(19) United States
(12) Patent Application Publication
(10) Pub. No.: US 2018/0011588 A1
(43) Pub. Date: Jan. 11, 2018

(54) DRIVING METHOD AND DEVICE AND DISPLAY DEVICE

(71) Applicant: BOE TECHNOLOGY GROUP CO., LTD., Beijing (CN)

(72) Inventors: Jianing LU, Beijing (CN); Hong WANG, Beijing (CN); Jingfei FANG, Beijing (CN); Bo WANG, Beijing (CN)

(21) Appl. No.: 15/544,799

(22) PCT Filed: Mar. 17, 2016
(86) PCT No.: PCT/CN2016/076582

§ 371 Date: Jul. 19, 2017

(30) Foreign Application Priority Data
Apr. 15, 2015 (CN) 201510178756.X

(51) Int. Cl. G06F 3/041

(52) U.S. Cl. CPC G06F 3/0416

(57) ABSTRACT

The present disclosure provides a driving method and device, and a display device, the driving device including an acquisition module configured to acquire a high frequency touch area of a touch panel, and a touch driving module configured to scan drive the touch panel, with the scanning frequency for the high frequency touch area acquired by the acquisition module larger than the scanning frequency for other areas. In the driving device provided by the present disclosure, the number of times of scanning the high frequency touch area may be increased under the condition that the total touch time is constant, thus improving the sensitivity of detection of the high frequency touch area. And for the other touch areas outside the high frequency touch area, although the number of scanning times is reduced, this will not affect the user experience too much.

### CROSS REFERENCE TO RELATED APPLICATIONS

This patent application is a National Stage Entry of PCT/CN2016/076582 filed on Mar. 17, 2016, which claims the benefit and priority of Chinese Patent Application No. 201510178756.X filed on Apr. 15, 2015, the disclosures of which are incorporated herein in their entirety as part of the present application.

### BACKGROUND

Embodiments of the present disclosure relate to the display technology, and particularly to a driving method and device and a display device.

With the rapid progress of display technology, the display device with a touch function gradually becomes more and more popular because of its visualized operation and other advantages. According to the relative position of the touch panel and the display panel, the existing display devices with touch functions may be divided into two types: on cell touch panel and in cell touch panel. Compared with the on cell touch panel, the in cell touch panel has a thinner thickness and higher light transmittance.

As the display panel develops towards large size and high-resolution, the in cell touch panel's own weaknesses increasingly constitute the bottleneck of its technology development. In order to make the display and touch not interfere with each other, the current practice is to drive the display and touch in a time division manner within the display time of a frame. As the time of a frame is relatively fixed, with the increase in resolution, the display time is longer and longer, leaving the touch time shorter and shorter. This results in a decrease in the touch scanning frequency, which in turn results in a reduced sensitivity of the touch detection.

### BRIEF DESCRIPTION

The present disclosure facilitates improving the sensitivity of touch detection.

In a first aspect, an embodiment of the present disclosure provides a driving device, including an acquisition module configured to acquire a high frequency touch area of a touch panel, and a touch driving module configured to scan drive the touch panel, with the scanning frequency for the high frequency touch area acquired by the acquisition module larger than the scanning frequency for other areas.

According to an exemplary embodiment of the present disclosure, the acquisition module is specifically configured to acquire a high frequency touch area of a touch panel according to a preset period.

According to an exemplary embodiment of the present disclosure, the driving device further includes a display driving module configured to display drive of the touch panel.

According to an exemplary embodiment of the present disclosure, the acquisition module is specifically configured to acquire a high frequency touch area corresponding to a changed display interface when the display interface displayed on the touch panel is changed.

According to an exemplary embodiment of the present disclosure, the acquisition module includes a statistical sub-module configured to acquire touch position information of the touch panel within a preset time and to determine a high frequency touch area of the touch panel based on the touch position information, the touch position information being for representing a position where the touch panel is touched, an acquisition sub-module configured to acquire the high frequency touch area determined by the statistical sub-module.

According to an exemplary embodiment of the present disclosure, the acquisition module is configured to acquire a high frequency touch area corresponding to a changed display interface when a display interface displayed on the touch panel is changed, the statistical sub-module is specifically configured to, for each display interface of a plurality of display interfaces, acquire touch position information of the touch panel when the display interface is displayed, and determine a high frequency touch area corresponding to the display interface according to the touch position information, the acquisition sub-module is specifically configured to acquire a high frequency touch area corresponding to a changed display interface when a display interface displayed on the touch panel is changed.

According to an exemplary embodiment of the present disclosure, the acquisition module further includes an encrypted storage sub-module, the statistical sub-module is further configured to store the determined high frequency touch area to the encrypted storage sub-module, the acquisition sub-module is specifically configured to acquire the high frequency touch area determined by the statistical sub-module from the encrypted storage sub-module.

According to an exemplary embodiment of the present disclosure, the acquisition module includes a communication sub-module configured to report identification information of each of a plurality of display interfaces and the touch position information corresponding to the display interface to a preset server so that the preset server determines a corresponding high frequency touch area when the touch panel displays each of the plurality of display interfaces based on the identification information of the display interface and the touch position information reported by a plurality of driving devices, wherein the touch position information is for representing a position where the touch panel is touched, a storage sub-module configured to acquire and store the high frequency touch area determined by the preset server for each display interface, an acquisition sub-module configured to acquire a high frequency touch area corresponding to a changed display interface from the storage sub-module when a display interface displayed on the touch panel is changed.

According to an exemplary embodiment of the present disclosure, the identification information of each display interface includes system type information of a display device to which the driving device belongs.

According to an exemplary embodiment of the present disclosure, the touch driving module is specifically configured to scan the high frequency touch area twice and scan the other areas once in each frame.

In a second aspect, the present disclosure also provides a driving method including acquiring a high frequency touch area of a touch panel, and scan driving the touch panel, with the scanning frequency for the acquired high frequency touch area larger than the scanning frequency for other areas.

According to an exemplary embodiment of the present disclosure, the acquiring a high frequency touch area of a touch panel includes acquiring a high frequency touch area of a touch panel according to a preset period.

According to an exemplary embodiment of the present disclosure, the driving method further includes display driving the touch panel.

According to an exemplary embodiment of the present disclosure, the acquiring a high frequency touch area of a touch panel includes acquiring a high frequency touch area corresponding to a changed display interface when a display interface displayed on the touch panel is changed.

According to an exemplary embodiment of the present disclosure, the acquiring a high frequency touch area of a touch panel includes acquiring touch position information of the touch panel within a preset time and determining a high frequency touch area of the touch panel based on the touch position information, the touch position information being for representing a position where the touch panel is touched, acquiring the determined high frequency touch area.

According to an exemplary embodiment of the present disclosure, the acquiring a high frequency touch area corresponding to a changed display interface when the display interface displayed on the touch panel is changed specifically includes for each display interface of a plurality of display interfaces, acquiring touch position information of the touch panel when the display interface is displayed, and determining a high frequency touch area corresponding to the display interface according to the touch position information, acquiring the determined high frequency touch area specifically includes when the touch panel displays one display interface of the plurality of display interfaces, acquiring a high frequency touch area determined for the display interface.

According to an exemplary embodiment of the present disclosure, the acquiring a high frequency touch area corresponding to the changed display interface when the display interface displayed on the touch panel is changed including reporting identification information of each display interface of a plurality of display interfaces and touch position information corresponding to the display interface to a preset server so that the preset server determines a corresponding high frequency touch area when the touch panel displays each display interface of the plurality of display interfaces based on the identification information and the touch position information of the display interface reported by a plurality of driving devices, wherein the touch position information is for representing a position where the touch panel is touched, acquiring and storing the high frequency touch area determined by the preset server for each display interface, when the touch panel displays one display interface of the plurality of display interfaces, acquiring a high frequency touch area corresponding to the display interface from the storage sub-module.

The present disclosure also provides a display device including a driving device according to any one of the above embodiments.

In the driving device provided by the present disclosure, since the scanning frequency for the high frequency touch area is larger than the scanning frequency for other areas, the number of times of scanning the high frequency touch area may be increased under the condition that the total touch time is constant, thus improving the sensitivity of detection of the high frequency touch area. And for the other touch areas outside the high frequency touch area, because it is less likely to be touched or not touched at all, although the number of times of scanning them is reduced, this will not affect the user experience too much.

### BRIEF DESCRIPTION OF THE DRAWINGS

FIG. 1 is a schematic structural diagram of a driving device according to an embodiment of the present disclosure;

FIG. 2 shows a possible display interface under an Android system;

FIG. 3 is a schematic structural diagram of a possible structure of the acquisition module in FIG. 1;

FIG. 4 is a schematic structural diagram of another possible structure of the acquisition module in FIG. 1;

FIG. 5 is a timing diagram of several related signals when the driving device of the present disclosure is in operation;

FIG. 6 is a flow diagram of a driving method provided by an embodiment of the present disclosure;

FIG. 7 is a flow diagram of a possible implementation of step S1 in FIG. 6; and

FIG. 8 is a flow diagram of another possible implementation of step S1 in FIG. 6.

### DETAILED DESCRIPTION OF SPECIFIC EMBODIMENTS

In order to elucidate the technical solutions and advantages of embodiments of the present disclosure, the technical solutions of embodiments of the present disclosure will now be described clearly and comprehensively. Obviously, the described embodiments are merely part of the embodiments, not all embodiments of the present disclosure. All other embodiments obtained by those of ordinary skill in the art based on the described embodiments of the present disclosure without making creative effort are within the scope of the present disclosure.

An embodiment of the present disclosure provides a driving device which may be used for driving touch detection. As shown in FIG. 1, the driving device may include an acquisition module 100 and a touch driving module 200, wherein the acquisition module 100 is configured to acquire a high frequency touch area of the touch panel, and the touch driving module 200 is configured to scan drive the touch panel, with the scanning frequency for the high frequency touch area acquired by the acquisition module larger than the scanning frequency for other areas.

In the driving device provided by the present disclosure, since the scanning frequency for the high frequency touch area is larger than the scanning frequency for other areas, the number of times of scanning the high frequency touch area may be increased under the condition that the total touch time is constant, thus improving the sensitivity of detection of the high frequency touch area. And for the other touch areas outside the high frequency touch area, because they are less likely to be touched or are not to be touched at all, although the number of times of scanning them is reduced, the user experience will not be affected much.

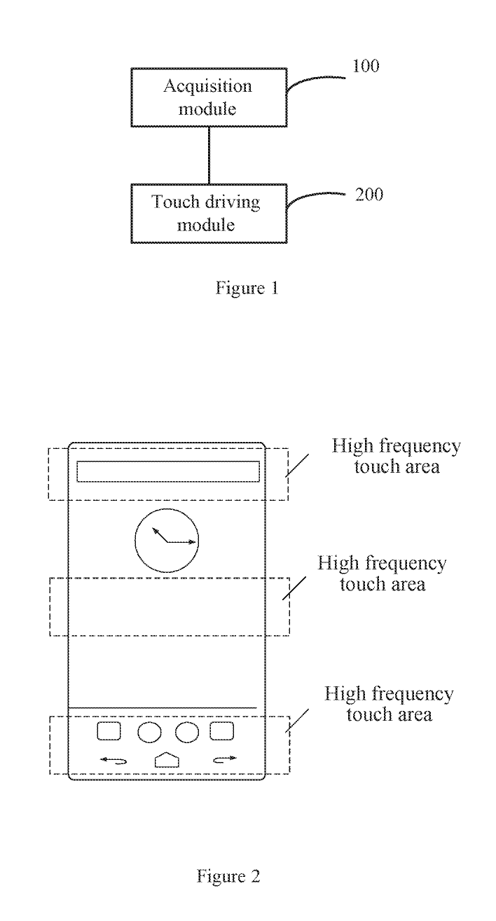

It is not difficult to understand that the high frequency touch area here refers to an area where the frequency of touch is higher than the other areas (by a certain value). Specifically, for example, for a display interface under an Android system shown in FIG. 2, when the user touches, primarily the touch frequencies for the touch areas of the upper area, the middle area, and the lower area of the display interface are relatively high, and for other touch areas, the touch frequencies are low, in which case, the touch area for the upper part of the display interface may be considered the high frequency touch area. In a specific implementation, the high frequency touch area may be defined by the designer, and input into the acquisition module.

In a specific implementation, the acquisition module 100 may be used to acquire a high frequency touch area of the touch panel according to a preset period.

In practice, a user may have different usage habits in different periods, and accordingly, the high frequency touch area of the touch panel may also be different in different periods. In the embodiment of the present disclosure, by making the acquisition module acquire the high frequency touch area of the touch panel according to a preset period, the acquired high frequency touch area may be made more conformable to the user's current usage habits, and accordingly, the response speed of the touch panel may be enhanced effectively.

In a specific implementation, the preset period may be set according to actual needs.

In a specific implementation, the above-described driving device may further include a display driving module not shown in FIG. 1 for display driving the touch panel.

Here, the touch panel may be a panel incorporating a display function. The display driving module may be a gate driving scan circuit for display driving the touch panel.

In a specific implementation, when the display drive module is included, the touch driving module 200 may be specifically configured to touch drive the touch panel when the display drive module does not display drive the touch panel. This may effectively avoid the interference on the display driving generated by the touch driving, so as to avoid affecting the display effect.

Further, the acquisition module 100 may be configured to acquire a high frequency touch area corresponding to the display interface when the display interface displayed on the touch panel is changed.

The advantage of this way is that different high frequency touch areas may be acquired for different display interfaces, and then different touch drivings may be performed. As in practical applications, different display interfaces are likely to correspond to different high frequency touch areas, such a way may enable the acquired high frequency touch area to be more in line with the current display of the touch panel, thus further improving the response speed.

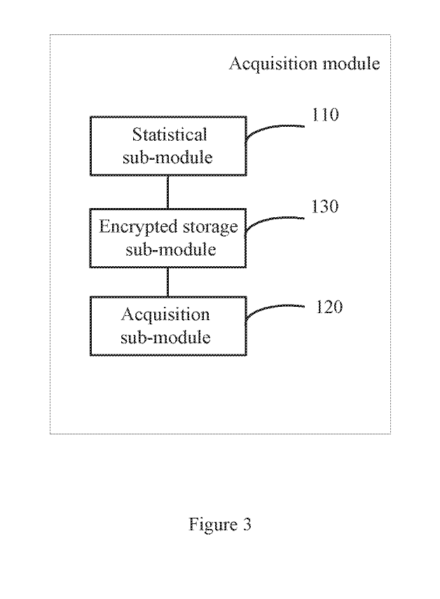

In a specific implementation, the acquisition module 100 may acquire a high frequency touch area by counting the touch information of the touch panel within a preset time, in which case, as described in FIG. 3, the acquisition module 100 may specifically include a statistical sub-module 110 configured to acquire the touch position information of the touch panel within a preset time, and determine a high frequency touch area of the touch panel based on the touch position information, the touch position information being for representing a position where the touch panel is touched, and an acquisition sub-module 120 configured to acquire the high frequency touch area determined by the statistical sub-module 110.

The advantages of this way are that, on one hand, the designer does not need to manually enter the high frequency touch area, on the other hand, the drive device may determine the high frequency touch area according to the actual use of the touch panel, making touch driving of the touch panel more in line with user habits, thus improving the touch response speed.

In a specific implementation, the touch position information here may be specifically the coordinate information of each touched point. The statistical sub-module 110 may be used to specifically divide the touch panel into a plurality of preset areas and to count the number of times each preset area is touched within a preset period of time, and if the number of times a preset area is touched within a preset period of time exceeds a preset value, it may be determined that the preset area is a high frequency touch area.

In a specific implementation, the statistical sub-module 110 may acquire the touch position information of the touch panel within a preset time by a touch sensor (a touch driving electrode Tx and a touch signal receiving electrode Rx).

In a specific implementation, the statistical sub-module 110 in the acquisition module 100 shown in FIG. 3 may be configured to count the touch information of the touch panel within a preset time and determine the high frequency touch area according to the preset period, or may be configured, for each display interface of a plurality of display interfaces, to specifically count the touch position information of the touch panel when the display interface is displayed, and to determine a high frequency touch area corresponding to the display interface according to the touch position information, wherein the acquisition sub-module 120 is specifically configured to acquire the high frequency touch area determined by the statistical sub-module 110 for the display interface when the display interface displayed on the touch panel is changed.

The advantage of this way is to be able to acquire different high frequency touch areas for different display interfaces, and then to perform different drives. As in practical applications, different display interfaces are likely to correspond to different high frequency touch areas, such a way may enable the acquired high frequency touch area more in line with the current display of the touch panel.

In a specific implementation, the acquisition module may further include an encrypted storage sub-module 130, and the statistical sub-module 110 is further configured to store the determined high frequency touch area into the encrypted storage sub-module 130, the acquisition sub-module 120 is specifically configured to acquire from the encrypted storage sub-module 130 the high frequency touch area determined by the statistical sub-module.

The advantage of this way is to avoid the corresponding information being accessed maliciously, so as to avoid the disclosure of personal information.

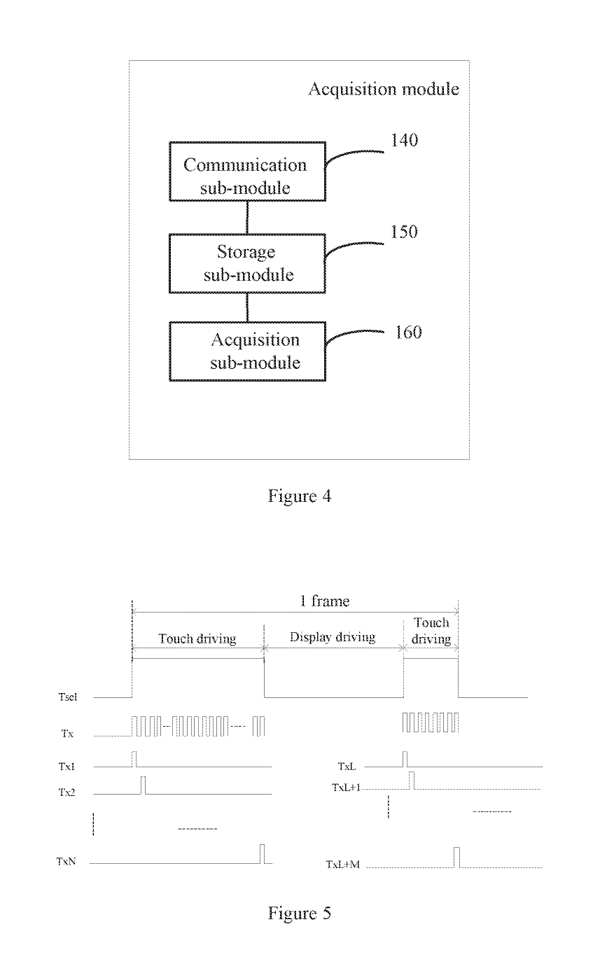

Alternatively, the acquisition module 100 may also report the touch information to a preset server (a cloud server), and the cloud server may determine the corresponding high frequency touch area, in which case, as shown in FIG. 4, the acquisition module 100 may include a communication sub-module 140 configured to report the identification information of each of a plurality of display interfaces and the touch position information corresponding to the display interface to a preset server so that the preset server may determine the corresponding high frequency touch area when the touch panel displays each display interface of the plurality of display interfaces on the basis of the identification information of the display interface and the touch position information reported by the driving device, wherein the touch position information is for representing a position where the touch panel is touched, a storage sub-module 150 configured to acquire and store the high frequency touch area determined by the preset server for each display interface, and an acquisition sub-module 160 configured to specifically acquire a high frequency touch area corresponding to the changed display interface when the display interface displayed on the touch panel is changed.

The implementation in which the touch information is reported to the preset server, and the preset server determines the high frequency touch area corresponding to each display interface may reduce the resource consumption and design difficulty of the driving device as compared with the implementation in which the statistical sub-module in the driving device performs the statistics. At the same time, because the preset server may receive the touch information reported by a large number of driving devices for the same display interface, and determine the high frequency touch area corresponding to the display interface according to the corresponding touch information, the statistical result is more accurate.

In a specific implementation, the identification information of each display interface may include the system type information of the display device to which the driving device belongs.

The fact that the identification information of each display interface includes the system type information of the display device to which the driving device belongs, will make the display interfaces whose system type information is different but contents are the same be recognized as different display interfaces, so that the preset server may determines different high frequency touch areas for display interfaces with different types but the same contents. Since the high frequency touch areas corresponding to a display interface under different system types are generally different, this way makes the acquired high frequency touch area more accurate.

Here the system type information is used to distinguish the system type of the corresponding display device, such as an Android system or an iOS system.

In a specific implementation, the communication sub-module 140 here may also be an encrypted communication module, where the storage sub-module 150 may also be an encrypted storage sub-module, thereby also preventing the user's personal information from being leaked.

In a specific implementation, as shown in FIG. 5, the touch driving module 200 is specifically configured to scan the high frequency touch area twice within each frame (assuming that the Tx lines corresponding to the high frequency touch area are TxL to TxL+M, and the entire touch area has a total of N rows of Tx lines), and to scan the other areas (corresponding to Tx lines Tx1 to TxL−1, TxL+M+1 to TxN) once.

The advantage of this way is to ensure that the non-high frequency touch areas are also scanned in each frame to avoid missed detection. Of course, in practical applications, if a display interface (such as in some game interface) has some areas that cannot possibly be touched, scan driving may also not be performed for the areas. In addition, the area of the high frequency touch area is relatively small, and the high frequency touch area may be scanned a plurality of times within one frame.

In a specific implementation, on the precondition that the technical problems raised by the present disclosure can be solved, it will not affect the protection scope of the present disclosure which physical structure each function module is provided in. For example, when the acquisition module 100 directly receives a high frequency touch area defined by the designer himself, the driving device here may be located in the timing controller T/CON. In this case, the acquisition module 100 here may be a storage having a data write interface in the timing controller, and the designer may write to the storage through the data write interface, and the touch driving module may be specifically a touch integrated circuit in the timing controller. The touch integrated circuit may be connected to the storage, and adjust the start time and the end time of a touch enable signal Tsel according to the high frequency touch area stored in the storage so that the frequency for the high frequency touch area is greater than the frequency for the non-high frequency touch areas in a frame.

Also shown in FIG. 5 is a timing diagram of a possible Tsel signal, which has two enable pulses in one frame, the first enable pulse is used to touch drive the entire area (corresponding to Tx1-TxN), and the second enable pulse (corresponding to TxL to TxL+M) is only used to touch drive the high frequency touch area, so that in a frame, the non-high frequency touch areas are scanned once, and the high frequency touch area are scanned twice.

In addition, when the acquisition module described above is the acquisition module as shown in FIG. 3, the acquisition sub-module here may be considered as a storage in the T/CON, and the statistical sub-module may be considered as the CPU of the display device. The encrypted storage sub-module in FIG. 3 described above may specifically be a storage in the CPU.

When the acquisition module described above is the acquisition module as shown in FIG. 4, the acquisition sub-module here may be considered as a storage in the T/CON, and the storage sub-module may be considered as a storage in the CPU.

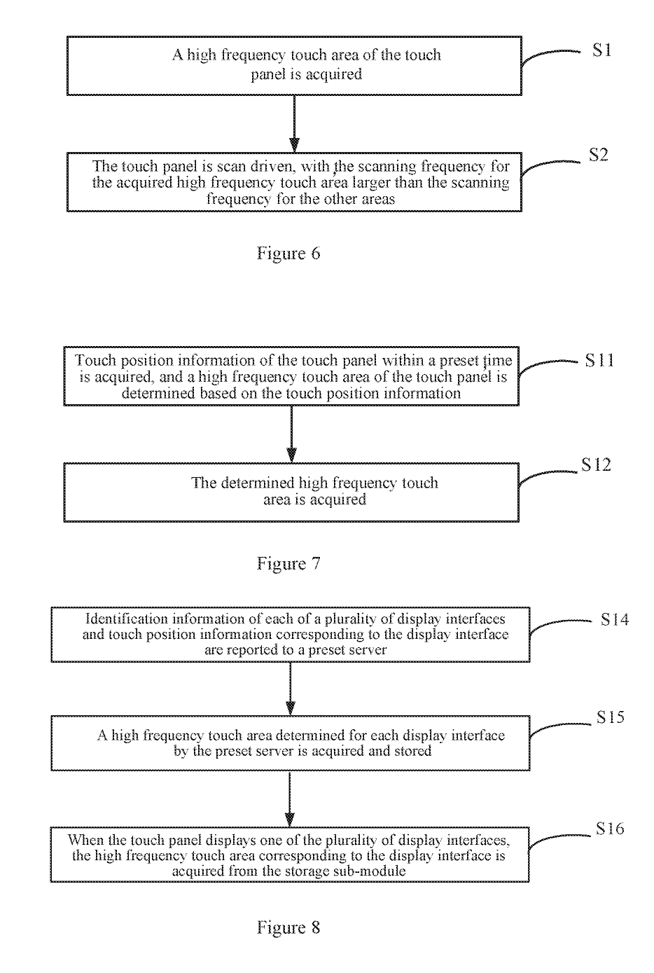

According to the same concept, an embodiment of the present disclosure also provides a driving method, as shown in FIG. 6, which includes:

in step S1, a high frequency touch area of the touch panel is acquired; and

in step S2, the touch panel is scan driven, with the scanning frequency for the acquired high frequency touch area larger than the scanning frequency for the other areas.

In the driving method provided by the embodiment of the present disclosure, since the scanning frequency for the high frequency touch area is larger than the scanning frequency for the other areas, the number of scanning times on the high frequency touch area may be enhanced under the condition that the total touch time is constant, thereby increasing the detection sensitivity of the high frequency touch area. And for other touch areas outside the high frequency touch area, since they are less likely to be touched or not touched at all, although the number of scanning times on them is reduced, this will not affect the user experience too much.

In a specific implementation, the step S1 may specifically include acquiring a high frequency touch area of the touch panel according to a preset period.

In a specific implementation, the method may further include display driving the touch panel.

Further, the step S1 may specifically include when the display interface displayed on the touch panel is changed, acquiring the high frequency touch area corresponding to the changed display interface.

Further, as shown in FIG. 7, the step S1 may specifically include:

in step S11, touch position information of the touch panel within a preset time is acquired, and a high frequency touch area of the touch panel is determined based on the touch position information, the touch position information being for representing a position where the panel is touched; and

in step S12, the determined high frequency touch area is acquired.

Further, when the display interface displayed on the touch panel is changed, acquiring the high frequency touch area corresponding to the changed display interface specifically includes for each display interface of a plurality of display interfaces, acquiring the touch position information of the touch panel when the display interface is displayed, and determining a high frequency touch area corresponding to the display interface according to the touch position information, the acquiring the determined high frequency touch area specifically includes when the touch panel displays one of the plurality of display interfaces, acquiring the high frequency touch area determined for the display interface.

Alternatively, as shown in FIG. 8, the step S1 may specifically include:

in step S14, identification information of each of a plurality of display interfaces and touch position information corresponding to the display interface are reported to a preset server so that the preset server may determine a corresponding high frequency touch area when the touch panel displays each of the plurality of display interfaces based on the identification information of display interfaces and touch position information reported by a plurality of driving devices, wherein the touch position information is for representing a position where the touch panel is touched;

in step S15, a high frequency touch area determined for each display interface by the preset server is acquired and stored; and

in step S16, when the touch panel displays one of the plurality of display interfaces, the high frequency touch area corresponding to the display interface is acquired from the storage sub-module.

In another aspect, an embodiment of the present disclosure further provides a display device including a driving device according to any one of the preceding items.

The display device here may be any product or component having display and touch functions such as a mobile phone, a tablet, or the like.

The foregoing is description of specific embodiments of the present disclosure, but the scope of the present disclosure is not limited thereto, and any person skilled in the art will be able to easily think of any changes or substitutions within the technical scope of the present disclosure, which are intended to be within the scope of the present disclosure. Accordingly, the scope of protection of the present disclosure should be based on the scope of protection of the claims.

1. A driving device comprising:
an acquisition module configured to acquire a high frequency touch area of a touch panel; and
a touch driving module configured to scan drive the touch panel, wherein a scanning frequency for the high frequency touch area acquired by the acquisition module is larger than a scanning frequency for other areas.

2. The driving device of claim 1, wherein the acquisition module is specifically configured to acquire a high frequency touch area of a touch panel according to a preset period.

3. The driving device according to claim 1, further comprising a display driving module configured to display drive the touch panel.

4. The driving device according to claim 3, wherein the acquisition module is specifically configured to acquire a high frequency touch area corresponding to a changed display interface when a display interface displayed by the touch panel is changed.

5. The driving device of claim 4, wherein the acquisition module comprises:
a statistical sub-module configured to acquire touch position information of the touch panel within a preset time and configured to determine a high frequency touch area of the touch panel based on the touch position information, the touch position information representing a position where the touch panel is touched; and
an acquisition sub-module configured to acquire the high frequency touch area determined by the statistical sub-module.

6. The driving device according to claim 1, wherein the acquisition module comprises:
a statistical sub-module configured to acquire touch position information of the touch panel within a preset time and configured to determine a high frequency touch area of the touch panel based on the touch position information, the touch position information representing a position where the touch panel is touched; and
an acquisition sub-module configured to acquire the high frequency touch area determined by the statistical sub-module.

7. The driving device according to claim 5, wherein;
the statistical sub-module is specifically configured to, for each display interface of a plurality of display interfaces, acquire touch position information of the touch panel when the display interface is displayed, and determine a high frequency touch area corresponding to the display interface according to the touch position information; and
the acquisition sub-module is specifically configured to acquire a high frequency touch area corresponding to a changed display interface when a display interface displayed on the touch panel is changed.

8. The driving device of claim 5, wherein the acquisition module further includes an encrypted storage sub-module, wherein the statistical sub-module is further configured to store the determined high frequency touch area to the encrypted storage sub-module, and wherein the acquisition sub-module is specifically configured to acquire the high frequency touch area determined by the statistical sub-module from the encrypted storage sub-module.

9. The driving device of claim 4, wherein the acquisition module comprises:
a communication sub-module configured to report identification information of each display interface of a plurality of display interfaces and touch position information corresponding to the display interface to a preset server so that the preset server determines a corresponding high frequency touch area when the touch panel displays each display interface of the plurality of display interfaces based on the identification information and the touch position information of the display interface reported by a plurality of driving devices, wherein the touch position information represents a position where the touch panel is touched;
a storage sub-module configured to acquire and store the high frequency touch area determined by the preset server for each display interface; and
an acquisition sub-module configured to acquire a high frequency touch area corresponding to a changed display interface from the storage sub-module when a display interface displayed on the touch panel is changed.

10. The driving device according to claim 9, wherein the identification information of each display interface includes system type information of a display device to which the driving device belongs.

11. The driving device according to claim 1, wherein the touch driving module is specifically configured to scan the high frequency touch area twice and scan the other areas once in each frame.

12. A driving method comprising:
acquiring a high frequency touch area of a touch panel; and
scan driving the touch panel, wherein a scanning frequency for the acquired high frequency touch area is larger than a scanning frequency for other areas.

13. The method of claim 12, wherein acquiring a high frequency touch area of a touch panel comprises:
acquiring a high frequency touch area of a touch panel according to a preset period.

14. The method of claim 12, further comprising:
display driving the touch panel.

15. The method of claim 14, wherein the acquiring a high frequency touch area of a touch panel comprises:
acquiring a high frequency touch area corresponding to a changed display interface when a display interface displayed on the touch panel is changed.

16. The method of claim 15, wherein the acquiring a high frequency touch area of a touch panel comprises:
acquiring touch position information of the touch panel within a preset time and determining a high frequency touch area of the touch panel based on the touch position information, the touch position information representing a position where the touch panel is touched; and
acquiring the determined high frequency touch area.

17. The method of claim 12, wherein acquiring a high frequency touch area of a touch panel comprises:
acquiring touch position information of the touch panel within a preset time and determining a high frequency touch area of the touch panel based on the touch position information, the touch position information representing a position where the touch panel is touched; and
acquiring the determined high frequency touch area.

18. The method according to claim 16, wherein acquiring a high frequency touch area corresponding to a changed display interface when the display interface displayed on the touch panel is changed comprises, for each display interface of a plurality of display interfaces, acquiring touch position information of the touch panel when the display interface is displayed, and determining a high frequency touch area corresponding to the display interface according to the touch position information, and wherein acquiring the determined high frequency touch area specifically comprises, when the touch panel displays one display interface of the plurality of display interfaces, acquiring a high frequency touch area determined for the display interface.

19. The method according to claim 15, wherein acquiring a high frequency touch area corresponding to a changed display interface when the display interface displayed on the touch panel is changed comprises:
reporting identification information of each display interface of a plurality of display interfaces and touch position information corresponding to the display interface to a preset server so that the preset server determines a corresponding high frequency touch area when the touch panel displays each display interface of the plurality of display interfaces based on the identification information and the touch position information of the display interface reported by a plurality of driving devices, wherein the touch position information represents a position where the touch panel is touched;
acquiring and storing the high frequency touch area determined by the preset server for each display interface; and
when the touch panel displays one display interface of the plurality of display interfaces, acquiring the high frequency touch area corresponding to the display interface from the storage.

20. A display device, comprising a driving device according to claim 1.
